(19) United States
(12) Patent Application Publication
(10) Pub. No.: US 2012/0251264 A1
(43) Pub. Date: Oct. 4, 2012

(54) FASTENER

(75) Inventor: Warren Taylor, Pacific Pines (AU)

(73) Assignee: WAMLEZ PTY LTD, Pacific Pines (AU)

(21) Appl. No.: 13/418,662

(22) Filed: Mar. 13, 2012

(30) Foreign Application Priority Data
Mar. 28, 2011 (AU) 2011901131

(51) Int. Cl. F16B 39/00; F16B 25/10; F16B 35/06; F16B 23/00

(52) U.S. Cl. 411/190; 411/394; 411/387.1; 411/404

(57) ABSTRACT

A fastener for locking two or more sheet sections together comprises a shaft tapered at one end and having a driving head at the other end with a relatively coarse thread running from the tapered end towards the head and a relatively fine thread between the coarse thread and the head. The fine thread has a pitch which is approximately equal to the thickness of the sheet sections and extends from the head for from two to six threads.

### FIELD OF THE INVENTION

This invention relates generally to fasteners and in particular to screws for securing metal sheets and rolled metal products.

### BACKGROUND OF THE INVENTION

In metal fabrication it is often necessary to fasten adjacent sheets of metal such as the webs of steel purlins or the overlapping junction of two cladding sheets. Typically fine threaded screws of constant pitch are used since a fine thread is required to draw the two sections together tightly when the screw is fully wound into the aligned guide holes drilled in the two sections.

A course threaded screw would not bring the sections closely together since the coarse thread allows separation of the sections even in the fully tightened configuration. In fact the pitch of the thread required to bring the sections together tightly is approximately equal to the thickness of the sections.

However a fine threaded screw requires many rotations to achieve full insertion, in fact one rotation for each of the threads of the screw. Further since the guide holes have a diameter somewhat less than the screw, the guide holes need to be in close alignment for insertion to start and considerable driving force is required to complete insertion. Accordingly the fastening of metal sections using such fine threaded screws is problematic and time consuming.

### OBJECT OF THE INVENTION

It is therefore an object of the present invention to provide a fastener for securing metal sheet sections which is easy to insert in guide holes and fast to drive, or at least provides an alternative to existing fasteners.

### STATEMENT OF THE INVENTION

According to the present invention a fastener for locking two or more sheet sections together comprises a shaft tapered at one end and having a driving head at the other end with a relatively coarse thread running from the tapered end towards the head and a relatively fine thread between the coarse thread and the head.

Preferably the fine thread has a pitch which is approximately equal to the thickness of the sheet sections and extends from the head for from two to seven threads.

Preferably the coarse thread extends from the tapered end for from two to seven threads and has a pitch from two to five times the pitch of the fine thread.

Alternatively the tapered end is self tapping.

Preferably the driving head is a recessed Philips head or a hexagonal head.

### BRIEF DESCRIPTION OF THE DRAWINGS

An embodiment of the invention is now described by way of example only with reference to the accompanying drawing in which:

FIG. 1 is a side view of a screw for fastening metal sheets

### DETAILED DESCRIPTION OF THE INVENTION

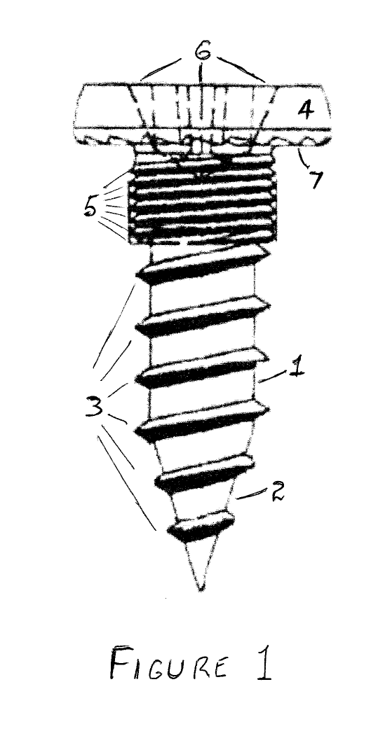

In FIG. 1 a steel screw for fastening metal sheets has shaft 1 with tapered tip 2 and coarse starting threads 3. The upper section of shaft 1 between coarse threads 3 and screw head 4 has much finer threads 5.

The pitch of threads 5 is approximately equal to the thickness of the sheets to be fastened and there are seven threads 5. Head 4 has recessed slots 6 to receive a Phillips head driver and the underside of head 4 has annular serrations 7. The annular serrations are angled to inhibit unscrewing movement (counterclockwise movement) of the screw.

Accordingly in use tapered tip 2 is inserted into the guide holes in the metal sections to be secured and head 4 is rotated by a driving tool with a Phillips head driver (not shown). Coarse threads 3 causes shaft 1 to travel quickly through the metal sections up to the start of fine threads 5 in just six rotations corresponding to six coarse threads 3.

At this point the metal sections are firmly held and the guide holes are closely aligned to receive fine threads 5. A further six rotations of shaft 1 result in complete insertion of the screw with the metal sections clamped firmly together between annular serrations 7 and the uppermost of fine threads 5.

Accordingly complete insertion of the screw is achieved in 12 rotations. A similar fine threaded screw requires at least 24 rotations and the initial insertion of the fine threaded tip in the undersized guide holes is problematic.

It will be obvious that the screw of the present invention with coarse starting threads and fine securing threads can be fully inserted to secure metal sections far more quickly and reliably than a screw with a constant fine pitch. There is also less steel required for the former since the coarse thread section has a reduced shaft diameter.

### VARIATIONS

It will be realized that the foregoing has been given by way of illustrative example only and that all other modifications and variations as would be apparent to persons skilled in the art including mechanical equivalents are deemed to fall within the broad scope and ambit of the invention as herein set forth. For example, the fasteners could be made with self tapping shaft tips and hexagonal or other heads to receive matching drivers. Further the fastener could be made from materials other than steel and modified to secure nonmetal sections but still using the basic principle of coarse starter threads and finer securing threads.

Throughout the description and claims of this specification the words “comprise” and variations of that word such as “comprises” and “comprising” are not intended to exclude other additives components integers or steps.

1. A fastener for locking two or more sheet sections together comprising a shaft tapered at one end and having a driving head at the other end with a relatively coarse thread running from the tapered end towards the head and a relatively fine thread between the coarse thread and the head.

2. The fastener of claim 1 in which the fine thread has a pitch which is approximately equal to the thickness of the sheet sections and extends from the head for from two to seven threads.

3. The fastener of claim 1 in which the coarse thread extends from the tapered end for from two to seven threads and has a pitch from two to five times the pitch of the fine thread.

4. The fastener of claim 1 in which the tapered end is self drilling.

5. The fastener of claim 1 in which the driving head is either a recessed Philips head or a hexagonal head.

6. The fastener of claim 1 further comprising annular serrations disposed on an underside of the head adjacent to the relatively fine thread.

7. A fastener for locking two or more sheet sections together comprising:
a shaft tapered at one end and having a driving head at the other end;
a relatively coarse thread running from the tapered end towards the head in which the coarse thread extends from the tapered end for from two to seven threads and has a pitch from two to five times the pitch of the fine thread; and
a relatively fine thread between the coarse thread and the head in which the fine thread has a pitch which is approximately equal to the thickness of the sheet sections and extends from the head for from two to seven threads.

8. The fastener of claim 7 in which the tapered end is self drilling.

9. The fastener of claim 7 in which the driving head is either a recessed Philips head or a hexagonal head.

10. The fastener of claim 7 further comprising annular serrations disposed on an underside of the head adjacent to the relatively fine thread, wherein the serrations are angled to inhibit unscrewing movement of the screw.
